(19) United States
(12) Patent Application Publication
(10) Pub. No.: US 2004/0215543 A1
(43) Pub. Date: Oct. 28, 2004

(54) Systems and methods for providing enhanced merchant contact detail for credit and debit card transactions

(76) Inventors: Mark S. Betz, Long Valley, NJ (US); David J. Hickey, Long Valley, NJ (US)

Correspondence Address: Joel N. Bock, Esq., SILLS CUMMIS EPSTEIN & GROSS P.C., One Riverfront Plaza, Newark, NJ, 07102-5400, US

(21) Appl. No.: 10/835,507

(22) Filed: Apr. 28, 2004

Related U.S. Application Data
(60) Provisional application No. 60/466,013, filed on Apr. 28, 2003.

(51) Int. Cl. G06F 17/60

(52) U.S. Cl. 705/35

(57) ABSTRACT

In a system and method for resolving transaction inquiries a database containing information relating to a merchant, including merchant contact information, and information relating to a transaction involving the merchant, including transaction date and location is coupled to a processor. The processor associates the merchant information with the transaction involving the merchant and controls the storage of the merchant contact information in the database in association with the transaction involving the merchant.

### CROSS-REFERENCE TO RELATED APPLICATION

The present invention claims priority from U.S. provisional patent application Ser. No. 60/466,013, filed on Apr. 28, 2003.

### FIELD OF THE INVENTION

The invention relates generally to the credit and debit card issuing, authorization, and billing systems in use by cardholders, card-issuing banks, transaction processors, transaction network operators, merchant-acquiring banks, and card-accepting merchants to process credit and debit card transactions. The invention relates specifically to the customer service processes, information workflows, and business rules utilized by card-issuing banks, transaction processors, transaction network operators, merchant-acquiring banks, and merchants to resolve cardholder inquiries into billed transaction validity and fulfillment.

### BACKGROUND OF THE INVENTION

Credit and debit cards are common financial tools used by consumers, private businesses, and government agencies to make more than 15 billion individual purchases annually. Current credit and debit card authorization and billing systems and messaging formats severely limit the amount of line-item descriptive information that can be transmitted from a point of sale for each individual transaction. Many times, line-item descriptive text does not include sufficient information to identify the merchant participant in a transaction so that the cardholder participant is able to contact the merchant when questions arise as to the validity or fulfillment of a billed transaction.

As a result of these limitations the cardholder participant in a transaction is often forced to contact the card-issuing bank when questions arise about the validity or fulfillment of a billed transaction. Currently card-issuing banks receive more than 100 million of these calls annually. Issuers estimate that more than 60 percent of these calls are due almost solely to the cardmember not recognizing the merchant name in the transaction description. The card-issuing bank typically does not have access to more merchant information than the cardholder, and is forced to either investigate the transaction manually by interviewing the cardholder, or initiate a formal Request for Information (RFI) through the credit and debit card networks. Such requests are also known as Media Requests, and Receipt Retrieval Requests. An RFI requires the merchant participant in a transaction to respond with supporting documentation including signed sales receipts, invoices, and shipment confirmations. The processing of such requests is the source of significant costs to credit and debit card issuers, acquirers, merchants, and network operators. It has been estimated that the cost to some card issuers from processing calls resulting from unrecognized merchant detail may reach $1.25 per active credit card account per year. Overall, the cost to card issuers to respond to unrecognized merchant detail inquiries may reach between $750 million to 1.5 billion annually. Costs to card issuers for processing all types of transaction inquiries may exceed $3 billion annually. FIG. 1 illustrates the flow of information in the current process.

Many card-accepting merchants find it difficult and costly to respond to an RFI in a timely manner. Failure to respond, or failure to respond within the prescribed timeframe, or failure to respond with information that satisfies the inquiring cardholder, results in the purchase transaction being charged back to the merchant by the card-issuing bank. Charged back transactions result in unexpected debits from the merchant's depository accounts, and high levels of charged back transactions may result in fines from the network operator(s), or restriction or suspension of card accepting privileges. The situation is most acute in Card Not Present/Mail Order Telephone Order (CNPIMOTO) transactions, where the merchant does not have a signed receipt to prove that a cardholder initiated and completed a given transaction.

Previous attempts to solve this problem have included enhancement of the transaction information flowing from the merchant to the card issuer, augmentation of the statement with additional merchant detail using publicly available sources, and augmentation of the statement with additional transaction line-item information. Each of these attempts has been unsuccessful in addressing the full scale of the problem. Both Visa and Mastercard have promoted the use of so-called “Level 3” transaction information, which can include line-item and merchant detail. However, level 3 data is generated only by certain merchants who accept corporate purchasing cards, and such purchasing cards generate a very low level of transaction inquiries and chargebacks. Furthermore, level 3 data is not being provided by card issuers and banks and cannot be economically provided to customers, and specifically, consumer sector customers, in part because of infrastructure limitations and accepted industry practices. MBNA, Citigroup, and others have attempted to add merchant detail to statements by linking recognizable transaction descriptions to publicly available information for the largest 100 merchants. This approach covers too few merchants, and the contact information provided is not targeted for customer service purposes, placing a burden on the merchant. Lastly, Visa has attempted to engineer a system that connects electronically-presented card statements to transaction line-item detail, utilizing an integration-focused approach that links merchants to billing systems. This effort was generally unsuccessful due to poor technical and economic metrics.

It is therefore desirable to provide apparatus, mechanisms and processes for the collection and dissemination of sufficient merchant contact information so as to enhance the ability of card-issuing banks and cardholders to resolve questions of transaction validity and fulfillment in the card-issuing bank's customer service call center, and within the card-issuing bank's electronic billing system, without resorting to the expensive process of initiating RFI and chargeback actions. Accordingly, there are numerous improvements disclosed herein which have been heretofore unknown in the art, which improve the effectiveness and efficiency of card-issuing banks and their billing systems in resolving cardholder inquiries into transaction validity or fulfillment.

### SUMMARY OF THE INVENTION

It is an object of the present invention to collect and disseminate improved merchant contact information for credit and debit card purchase transactions.

One embodiment of the present invention uses a software algorithm for creating a functionally unique merchant index key from the description, city, state, and merchant category code fields included in a credit or debit card transaction.

Another embodiment of the present invention uses a software algorithm and supporting method and apparatus for capturing merchant point-of-sale transaction descriptions from the billing transaction stream, and associating them with specific merchant contact information.

It is a further object of the present invention to provide a data processing system and methods and apparatus for the storage, online access, and maintenance of merchant contact profile records, indexed by a functionally unique key formed from transaction billing detail.

It is an object of one embodiment of the present invention to provide a method and apparatus for storing merchant contact profile records in a hierarchical way that allows for multiple contact profile records to be related to a single merchant entity, for multiple unique billing transaction keys.

Still another embodiment of the present invention uses a software algorithm and data processing system and methods and apparatus for enhancing the description field of a credit or debit card billing transaction to provide an understandable merchant description.

One embodiment of the present invention uses a method and apparatus for accessing and modifying merchant contact profile records using the HTTP network protocol and XML data formats and HTML documents.

Another embodiment of the present invention uses a method and apparatus for merchant contact profile establishment and maintenance by the merchant using the HTTP network protocol and XML data formats and HTML documents.

Still another embodiment of the present invention uses a method and apparatus for merchant contact profile establishment and maintenance by merchant acquiring banks using the HTTP network protocol and XML data formats and HTML documents.

Certain embodiments of the present invention use a method and apparatus for accessing merchant contact profile information in the card-issuing bank's customer service call center using the HTTP network protocol and XML data formats and HTML documents.

Certain embodiments of the present invention provide a method and apparatus for integrating merchant contact profile information into the card-issuing bank's electronic billing system using the HTTP network protocol and XML data formats and HTML documents.

In accordance with the various embodiments of the present invention, a number of new forms of data processing systems, methods and apparatuses are disclosed herein.

### BRIEF DESCRIPTION OF THE DRAWINGS

FIG. 1 is an illustration of the information flow within the current system for handling cardholder inquiries into transaction validity or fulfillment.

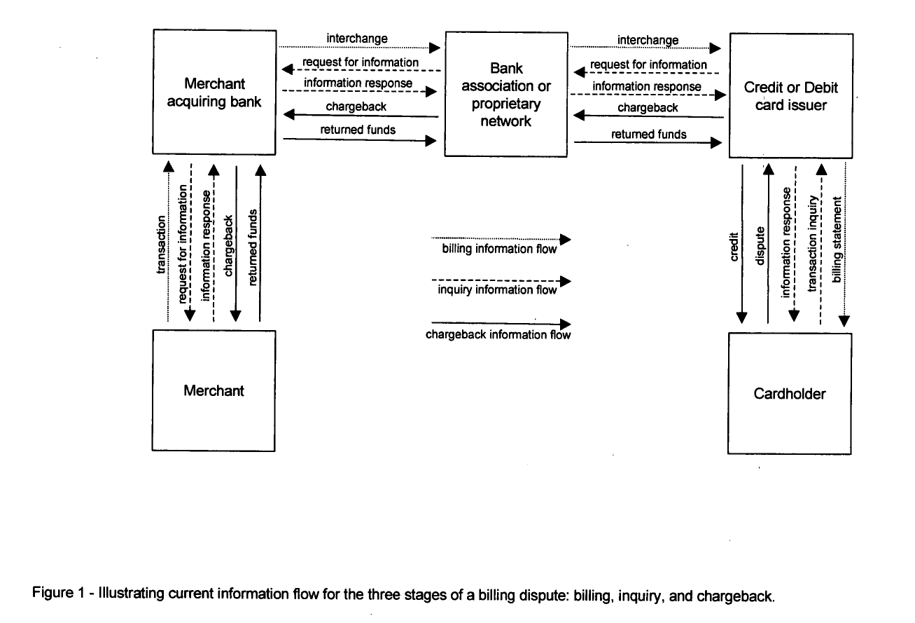

FIG. 2 is an illustration of a typical credit/debit card billing statement with transaction item (“RESTAURANT.COM . . . ”) highlighted, outlining the truncated transaction description field.

FIG. 3 illustrates the statement example from FIG. 1 with expanded merchant contact information displayed for a specific transaction.

FIG. 4 is an illustration of the fields within the ISO 8583 credit and debit card billing transaction message that may be used to create a functionally unique merchant index key.

FIG. 5 illustrates an algorithm used to create a unique merchant index key and prepare the key to be used for high performance merchant contact profile lookup processes.

FIG. 6 illustrates an alternative algorithm which captures the point of sale descriptor information for a merchant from the billing stream.

FIG. 7 illustrates the use of the functionally unique merchant index key in a single merchant contact profile record lookup transaction.

FIG. 8 is an illustration of a XML merchant contact return record.

FIG. 9 is an illustration of data records and relationships in the merchant contact profile database.

FIG. 10 is a schematic of a HTTP network established to facilitate collection and distribution of merchant contact profile records.

### DETAILED DESCRIPTION

Throughout this specification, references are made to algorithms and algorithms performing actions, What is meant, by these references, is that the various systems and methods of the present invention by implementing the algorithm(s) are thereby enabled to perform the action(s).

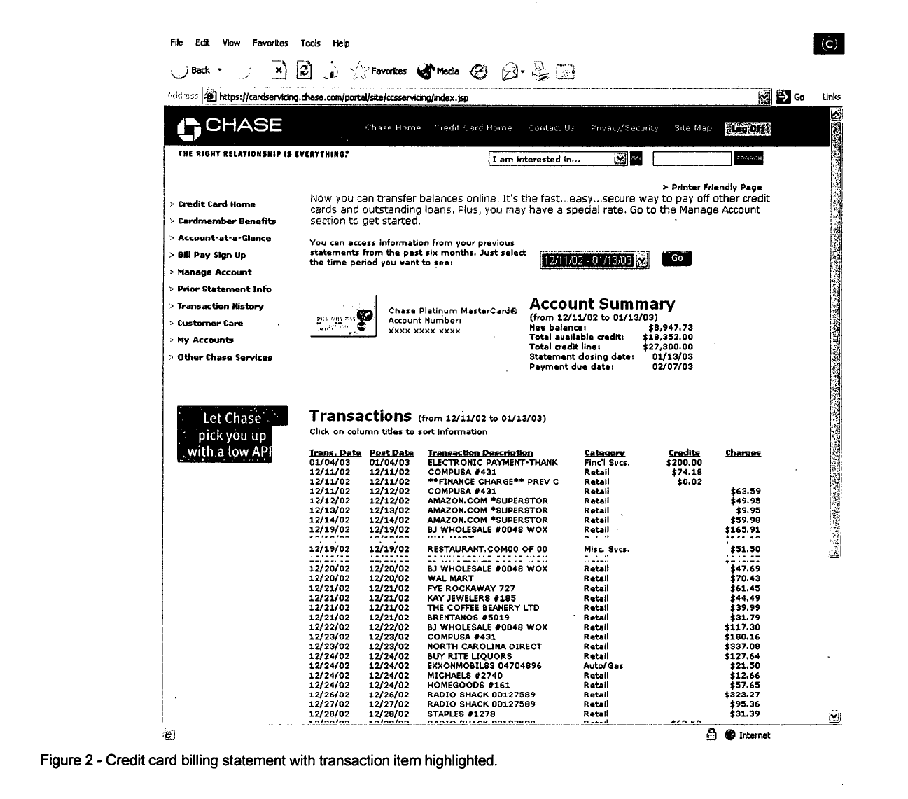

FIG. 2 illustrates a typical credit/debit card billing statement with the description, city, and state fields highlighted. Several of the transactions on the example statement illustrate the limitations of the ISO 8583 financial transaction messaging formats from which this information is ultimately derived by the card issuer for inclusion in the cardholder's monthly billing statement. Specifically there are severe length constraints on the description field which makes it unable to transmit sufficient merchant descriptive and contact information.

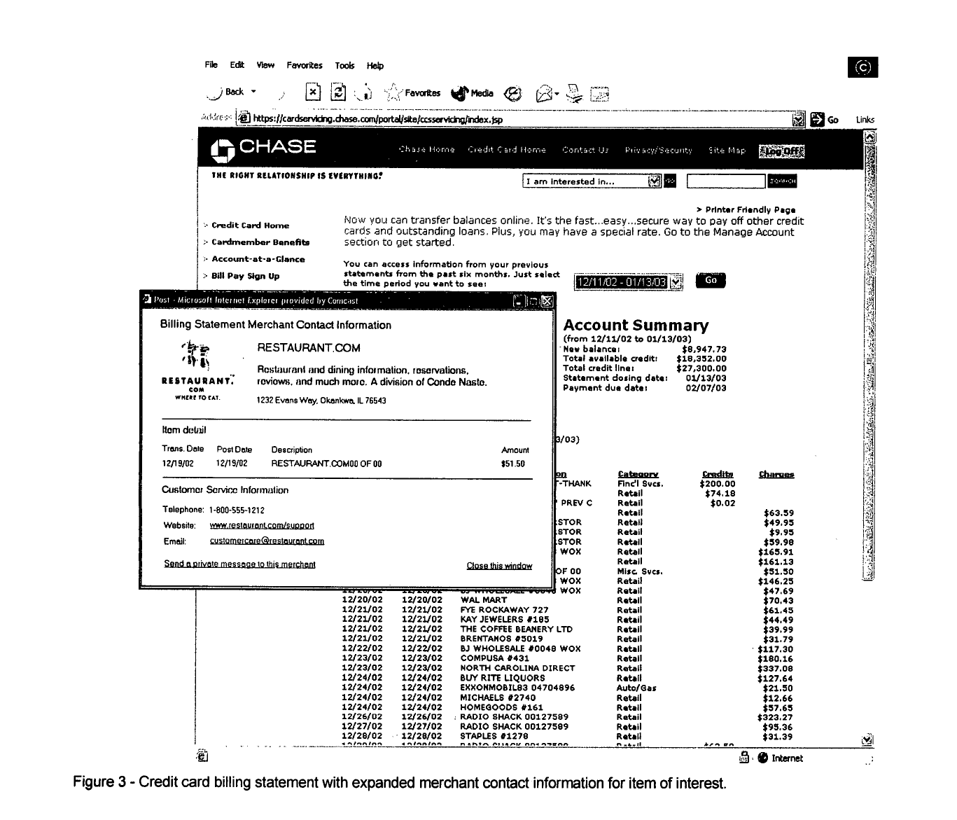

FIG. 3 illustrates a benefit of one embodiment of the present invention by showing an example of expanded merchant descriptive and contact information being displayed for a specific transaction- In order to provide the illustrated information the present invention provides improvements to overcome two key problems: a) the functionally unique identification of a merchant participant from standard credit and debit card billing information available to the card-issuing bank in the call center and electronic billing system environments; and b) the collection, storage, and maintenance of merchant contact profile data using a data processing system and mechanisms that provide access to the stored information using the HTTP network protocol and XML data formats and HTML documents. The component of the system specifically related to storage of the merchant contact profile records is hereinafter referred to as the Merchant Profile Database (MPD).

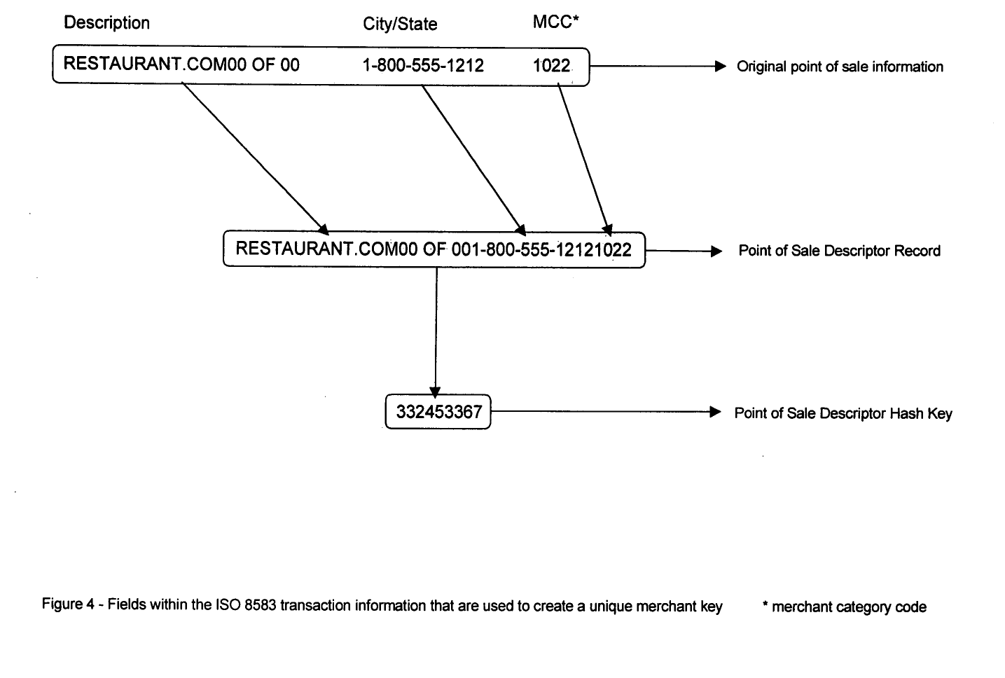

FIG. 4 illustrates the four fields from the credit or debit card transaction billing detail that are used to create a functionally unique index key for any given merchant in accordance with a preferred embodiment of the present invention. Three of these fields, DESCRIPTION, CITY, and STATE are typically printed on the monthly statements that are mailed to cardholders. The fourth field, MERCHANT CATEGORY CODE (MCC), is typically not printed on the monthly statement, and is typically available to issuer customer service representatives working in the customer service call center environment, and is also sometimes provided to the cardholder in an electronic online billing system environment. This field contains a code from a standard set of codes established and maintained by Visa and Mastercard, which are derived from Standard Industrial Classification (SIC) codes created and maintained by the U.S. government. These codes index standard text descriptions for broad categories of commercial activities; such that they give a general description of the kind of business the merchant participant in a transaction is engaged in.

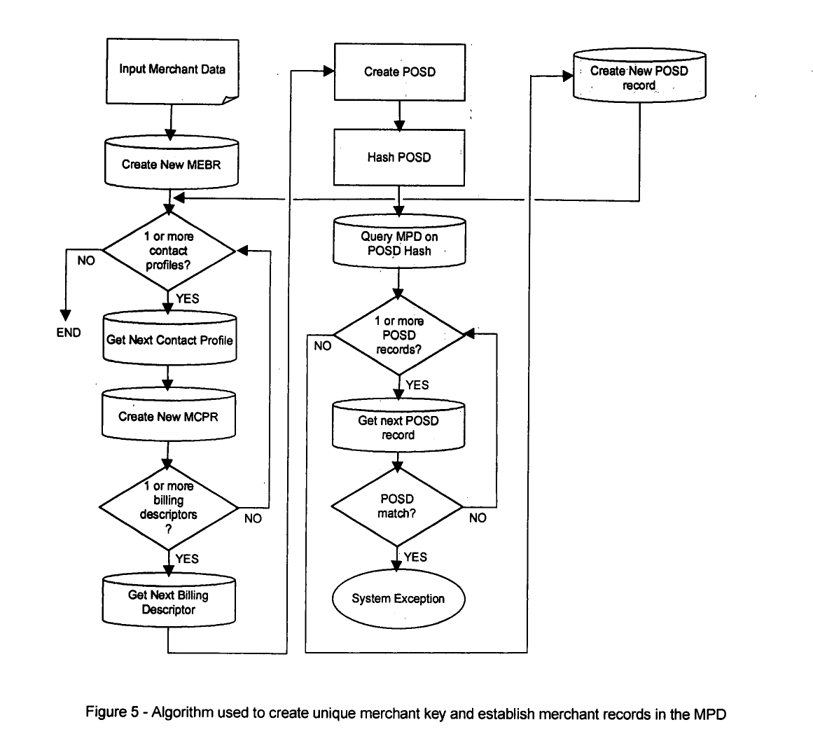

The functionally unique merchant index key for each merchant is created when the merchant contact profile record is first established. FIG. 5 illustrates an algorithm used to create the unique merchant key. The key is created according to the following algorithm:

1. On establishment of a new merchant entity in the MPD the merchant submits corporate entity information, one or more sets of billing transaction detail records including the four fields described above, and contact profile information for each set of one or more billing transaction detail records that are to be associated with a separate customer service contact profile record.

2. For each billing transaction detail record the algorithm first concatenates the DESCRIPTION, CITY, STATE, and MERCHANT CATEGORY CODE fields into a single text field, called the Point of Sale Descriptor (POSD).

3. The algorithm next transforms the POSD field using a mathematical process known as a One-way Hash to generate a numeric Hash Value that can be used to quickly access a restricted set of POSD records in the database.

4. The algorithm next performs a query on the MPD to determine if the Hash Value for the new POSD is already present in the database. If the query returns I ton records the algorithm performs a text comparison of the new POSD with the POSD records associated with the Hash Value in the MPD.

5. If an exact match on the POSD record is located, the algorithm generates an exception message. The exception message is processed by the system to generate a message to the end user with a notification that the POSD record has been previously registered.

6. If no exact match on the POSD record is located, and the merchant entity information has not already been established in the MPD, the algorithm creates a new Merchant Entity Base Record (MEBR) in the MPD using the information submitted by the merchant. The algorithm assigns the new MEBR a unique numeric identifier called the Merchant Entity ID (MEID), and stores this value with the MEBR in the MPD.

7. The algorithm then creates the Merchant Contact Profile Record (MCPR) to be associated with the POSD if it has not previously been created for another POSD in the set of one or more POSD records to be associated with the specific MCPR. The MCPR record includes the unique MELD of the MEBR it is associated with. The algorithm assigns each MCPR a unique numeric identifier called the Merchant Contact Profile ID (MCPID).

8. The algorithm then creates a new POSD record in the MPD containing the POSD descriptor generated in step 2. The POSD record is keyed to the MCPR with which it is to be associated using the MCPID. The algorithm assigns each POSD record in the MPD a unique numeric identifier called the POSDID.

9. If there are no further billing transaction detail records to be processed the algorithm generates a completion message, otherwise processing continues with step 2.

The effect of this algorithm is to create a functionally unique entity record for the merchant with a unique numeric identifier. This identifier is used to associate the merchant entity with one or more customer service contact profiles, each of which in turn is associated with one or more point of sale descriptor records. The point of sale descriptor records are stored along with the associated Hash Value to provide for high performance access as described below. The present invention is therefore compatible with diverse scenarios including a small merchant with a single point of sale and a single customer service contact number, as well as large merchants with multiple points of sale that may be serviced by multiple customer service contact centers.

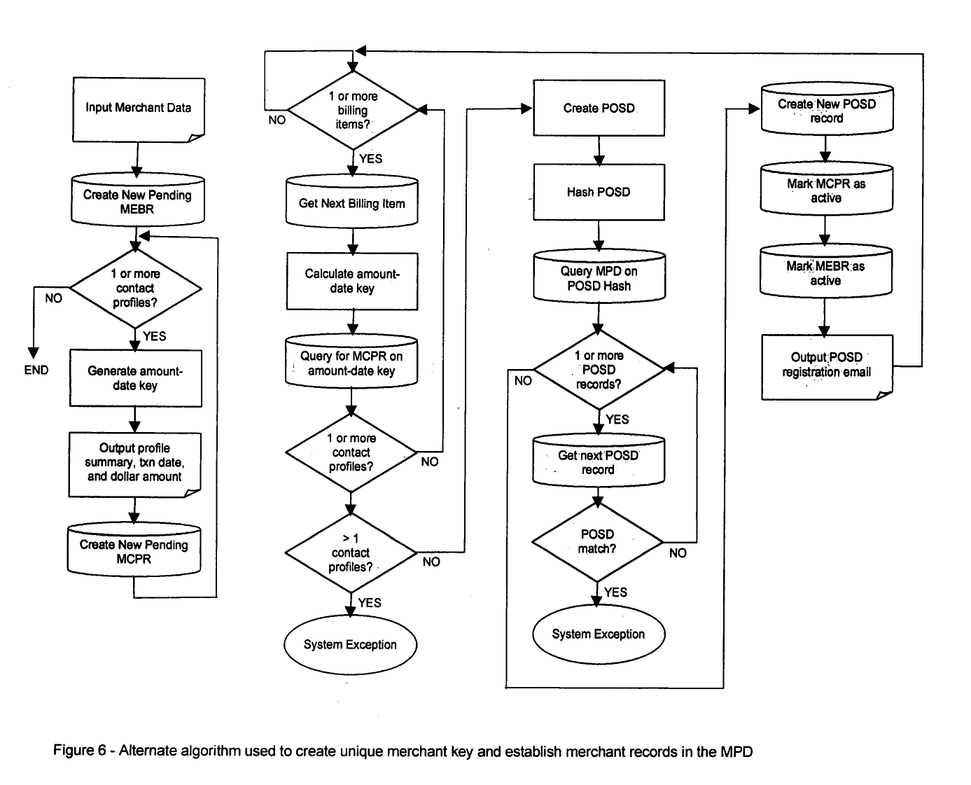

An alternative algorithm, illustrated in FIG. 6, is supported for cases where the merchant and/or acquirer do not have access to accurate records of the POSD information to be associated with a specific merchant contact profile.

1. On establishment of a new merchant entity in the MPD the merchant submits corporate entity information, and contact profile information for each set of one or more points of sale that are to be associated with a separate customer service contact profile record,

2. The algorithm generates a dollar amount for each merchant contact profile record submitted, and presents the amount to the enrolling merchant. The dollar amount is significant to the one cent column, and is used along with the transaction date to form a key such that, on any given day, this key will be unique for each merchant contact profile record submitted by a merchant enrolling in the system on that day.

3. The algorithm creates a new Merchant Entity Base Record (MEBR) in the MPD using the information submitted by the merchant. The algorithm assigns the new MEBR a unique numeric identifier called the Merchant Entity ID (MELD), and stores this value with the MEBR in the MPD. The algorithm marks the MEBR as a pending enrollment by setting a flag.

4. For each set of contact profile information submitted, the algorithm creates the Merchant Contact Profile Record (MCPR). The MCPR includes the unique MELD of the MEBR with which it is associated. The MCPR also includes the amount-date key generated for it in step 2. The algorithm assigns each MCPR a unique numeric identifier called the Merchant Contact Profile ID (MCPID). The algorithm marks the MCPR as a pending enrollment by setting a flag.

5. The merchant generates a standard purchase transaction from each point of sale associated with each of the merchant contact profile records submitted, using the dollar purchase value assigned to that contact profile record by the algorithm during the enrollment process.

6. The algorithm monitors the incoming purchase transactions for the supplied card account. For each transaction the dollar purchase amount is used along with the transaction date to form a key. The system queries the MPD to find any merchant contact profile records that have the same amount-date key, and are marked pending.

7. If no merchant contact profile record is returned from the query the algorithm continues at step 6.

8. If more than one merchant contact profile record is returned the system generates an exception message. Uniqueness constraints on the MPD should prevent this situation from occurring. This exception is processed by the system resulting in notification to the system operator of database corruption.

9. The algorithm extracts from the billing transaction the DESCRIPTION, CITY, STATE, and MERCHANT CATEGORY CODE fields, and concatenates them into a single text field, called the Point of Sale Descriptor (POSD).

10. The algorithm next transforms the POSD field using a mathematical process known as a One-way Hash to generate a numeric Hash Value that can be used to quickly access a restricted set of POSD records in the database.

11. The algorithm next performs a query on the MPD to determine if the Hash Value for the new POSD is already present in the database. If the query returns 1 to n records the algorithm performs a text comparison of the new POSD with the POSD records associated with the Hash Value in the MPD.

12. If an exact match on the POSD record is located, the algorithm generates an exception message. The exception message is processed by the system to generate a message to the end user with a notification that the POSD record has been previously registered.

13. Otherwise the algorithm creates a new POSD record in the MPD containing the POSD descriptor generated in step 9. The POSD record includes the unique MCPID of the MCPR with which it is to be associated. The algorithm assigns each POSD record in the MPD a unique numeric identifier called the POSDID.

14. The algorithm marks the merchant contact profile record active by resetting the flag that was set in step 4.

15. The algorithm then uses the MELD from the merchant contact profile record to query for the merchant entity base record, and marks this record as active by resetting the flag that was set in step 3.

The algorithm generates a completion email message to the merchant email address contained in the MERCH_ENTITY_MAINT_EMAIL field of the merchant entity base record, completing enrollment.

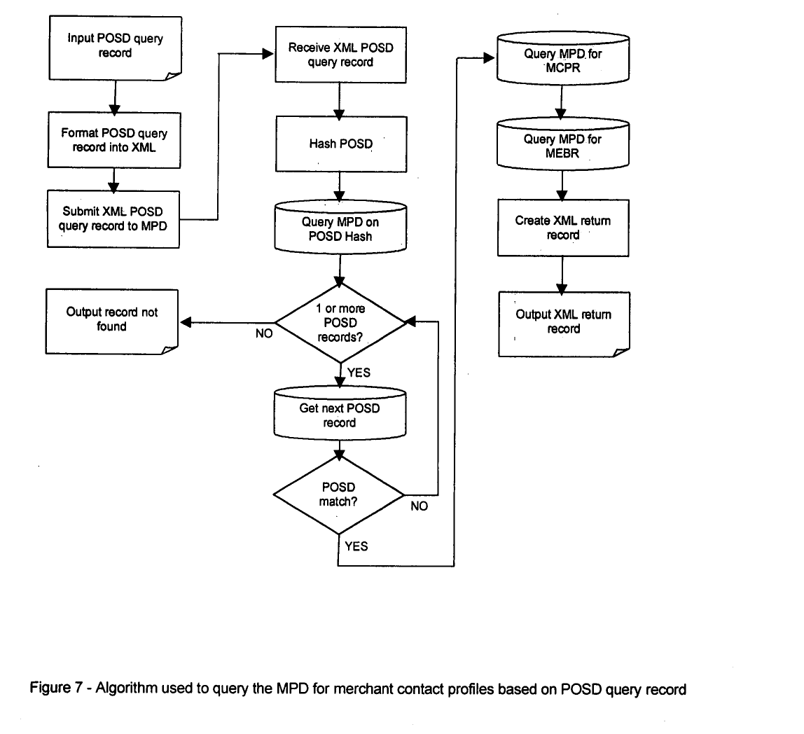

FIG. 7 illustrates the algorithm used to access a specific MCPR in the MPD using the POSD record from a specific transaction in a cardholder's monthly billing statement. The access is performed according to the following algorithm:

1. The party performing the lookup creates a POSD query record by concatenating the DESCRIPTION, CITY, STATE, and MERCHANT CATEGORY CODE fields from the transaction of interest in the billing statement.

2. The POSD query record is formatted into an XML query record and transmitted to the MPD using the HTTP network protocol.

3. The algorithm transforms the POSD query record using the same One-way Hash process used to establish the original POSD record in the database. The algorithm then queries the MPD using the resulting hash value.

4. If no POSD records are returned for the queried hash value the algorithm generates an exception.

5. For each POSD record that is returned for the queried hash value the algorithm performs a text comparison between the POSD query record and the POSD database record.

6. If an exact textual match is found the algorithm proceeds with step 8. otherwise the algorithm proceeds with step 5.

7. If no POSD record is found that is an exact match for the POSD query record the algorithm generates an exception.

8. Otherwise the system retrieves the MCPID from the POSD database record that exactly matched the POSD query record, and uses this value to query the MPD for the MCPR.

9. If the query returns no MCPR from the database, the algorithm generates an exception. Entity relationship constraints on the MPD will in general prevent this exception from occurring except in rare cases of corruption of the MPD itself This exception is processed by the system resulting in notification to the system operator of database corruption.

10. Otherwise the algorithm then retrieves the MEID from the returned MCPR and uses this value to query the MPD for the MEBR.

11. If the query returns no MEBR from the database, the algorithm generates an exception. Entity relationship constraints on the MPD will in general prevent this exception from occurring except in rare cases of corruption of the MPD itself This exception is processed by the system resulting notification to the system operator of database corruption.

12. The algorithm then formats specific data from the MCPR and MEBR into an XML formatted Merchant Contact Profile Message and returns this message to the party performing the lookup using the HTTP networking protocol.

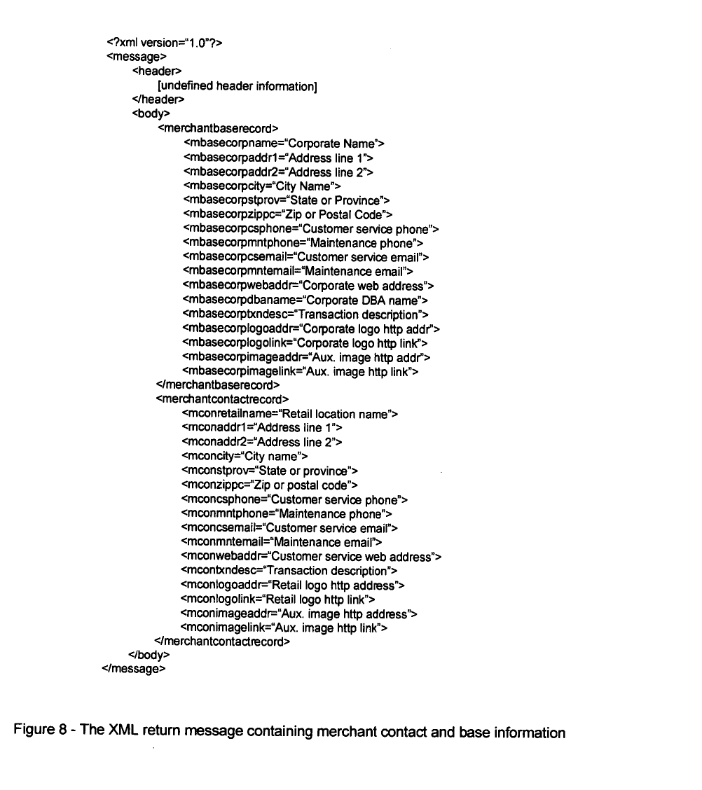

FIG. 8 illustrates the contents of a Merchant Contact Profile Message, which is a combination of data from the Merchant Entity Base Record and Merchant Contact Profile Record established in the MPD. Embodiments of the present invention may include more or less or different information, in order to satisfy the goal of providing sufficient detail to allow the card-issuing bank/cardholder to identify and contact the merchant when a question arises about the validity or fulfillment of a billed transaction. The information stored in the Merchant Entity Base Record and Merchant Contact Profile Records nominally includes the following fields:

Merchant Entity Base Record

1. MERCH_ENTITY_CORP_NAME

Field containing the legal name of the incorporated commercial entity doing business as the merchant.

2. MERCH_ENTITY_CORP_ADDR1

Field containing the physical street address of the incorporated commercial entity doing business as the merchant, line 1.

3. MERCH_ENTITY_CORP_ADDR2

Field containing the physical street address of the incorporated commercial entity doing business as the merchant, line 2.

4. MERCH_ENTITY_CORP_CITY

Field containing the physical street address of the incorporated commercial entity doing business as the merchant, city.

5. MERCH_ENTITY_CORP_STATEPROV

Field containing the physical street address of the incorporated commercial entity doing business as the merchant, state or province

6. MERCH_ENTITY_CORP_ZIPPC

Field containing the physical street address of the incorporated commercial entity doing business as the merchant, zip or postal code.

7. MERCH_ENTITY_CUSTSRVC_PHONE

Field containing the customer service telephone number of the incorporated commercial entity doing business as the merchant.

8. MERCH_ENTITY_MAINT_PHONE

Field containing the telephone number of the incorporated commercial entity doing business as the merchant, to be used for system maintenance contact.

9. MERCH_ENTITY_CUSTSRVC_EMAIL

Field containing the customer service SMTP protocol email address of the incorporated commercial entity doing business as the merchant.

10. MERCH_ENTITY_MAINT_EMAIL

Field containing the SMTP protocol email address of the incorporated commercial entity doing business as the merchant, to be used for system maintenance contact.

11. MERCH_ENTITY_WEB_ADDR

Field containing the HTTP protocol address of the website maintained by the incorporated commercial entity doing business as the merchant.

12. MERCH_ENTITY_DBA_NAME

Field containing the name that the incorporated commercial entity doing business as the merchant normally uses in retail commercial operations.

13. MERCH_ENTITY_TXN_DESCR

Field containing the text description of the merchant business that should be attached to billed transactions when displayed.

14. MERCH_ENTITY_LOGO_ADDR

Field containing the HTTP protocol address of an image representing the logo of the incorporated commercial entity doing business as the merchant.

15. MERCH_ENTITY_LOGO_LINK

Field containing the HTTP protocol address that users should be directed to by their web browser when the merchant logo is clicked.

16. MERCH_ENTITY_IMAGE_ADDR

Field containing the HTTP protocol address of an optional image that a merchant entity may request to be displayed along with the contact information.

17. MERCH_ENTITY_IMAGE_LINK

Field containing the HTTP protocol address that users should be directed to by their web browser when the optional image is clicked.

Merchant Contact Profile Record

1. MERCH_CONTACT_RETAIL_NAME

Field containing the public display name of the retail location associated with a point of sale descriptor record (POSD).

2. MERCH_CONTACT_ADDR1

Field containing the physical street address associated with a point of sale descriptor record, line 1.

3. MERCH_CONTACT_ADDR2

Field containing the physical street address associated with a point of sale descriptor record, line 2.

4. MERCH_CONTACT_CITY

Field containing the physical street address associated with a point of sale descriptor record, city.

5. MERCH_CONTACT_STATEPROV

Field containing the physical street address associated with a point of sale descriptor record, state or province.

6. MERCH_CONTACT_ZIPPC

Field containing the physical street address associated with a point of sale descriptor record, zip or postal code.

7. MERCH_CONTACT_CUSTSRVC_PHONE

Field containing the customer service telephone number associated with a point of sale descriptor record.

8. MERCH_CONTACT_MAINT_PHONE

Field containing the telephone number associated with a point of sale descriptor record, to be used for system maintenance contact.

9. MERCH_CONTACT_CUSTSRVC_EMAIL

Field containing the SMTP protocol customer service email address associated with a point of sale descriptor record.

10. MERCH_CONTACT_MAINT_EMAIL

Field containing the SMTP protocol email address associated with a point of sale descriptor record, to be used for system maintenance contact.

11. MERCH_CONTACT_WEB_ADDR

Field containing the HTTP protocol address of the customer service website associated with a point of sale descriptor record.

12. MERCH_CONTACT_TXN_DESCR

Field containing the text description of the merchant's retail business associated with a point of sale descriptor record.

13. MERCH_CONTACT_LOGO_ADDR

Field containing the HTTP protocol address of an image representing the logo of the retail merchant associated with a point of sale descriptor record

14. MERCH_CONTACT_LOGO_LINK

Field containing the HTTP protocol address that users should be directed to by their web browser when the merchant contact logo is clicked.

15. MERCH_CONTACT_IMAGE_ADDR

Field containing the HTTP protocol address of an optional image that a merchant entity may request to be displayed along with the contact information.

16. MERCH_CONTACT_IMAGE_LINK

Field containing the HTTP protocol address that users should be directed to by their web browser when the optional image is clicked.

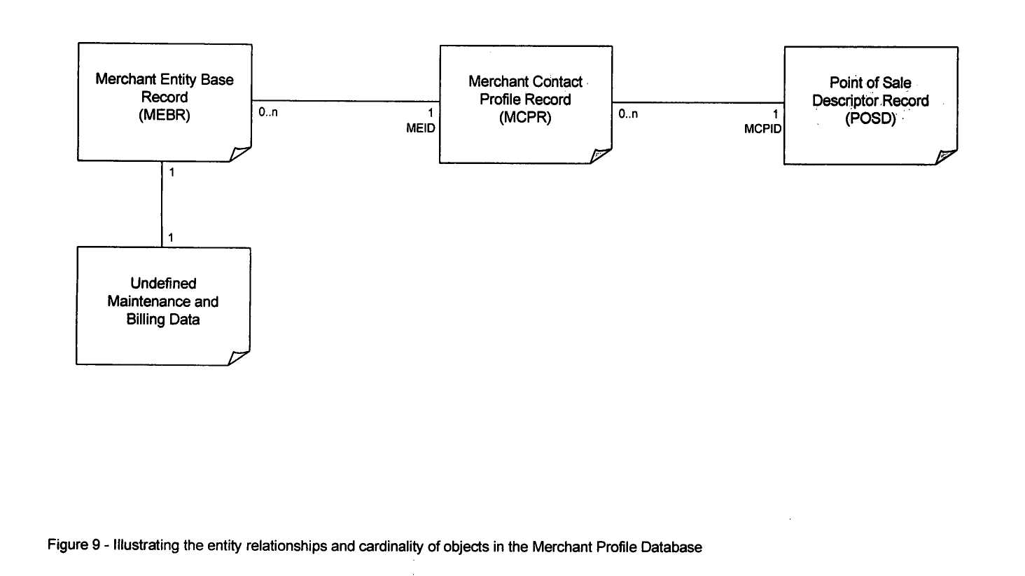

FIG. 9 gives a schematic view of the entity relationships between records in the Merchant Profile Database (MPD) in accordance with a preferred embodiment of the present invention. An important feature of the database organization is its ability to maintain multiple Merchant Contact Profile Records for each Merchant Entity Base Record, and multiple Point of Sale Descriptor Records for each Merchant Contact Profile Record. This set of data relationships allows the system to accommodate diverse scenarios, including small merchants with a single point of sale serviced by a single customer contact point, and larger merchants with multiple points of sale potentially serviced by multiple customer contact points. Additional information is maintained in the MPD, and not described in FIG. 9, for the purpose of system maintenance and operation.

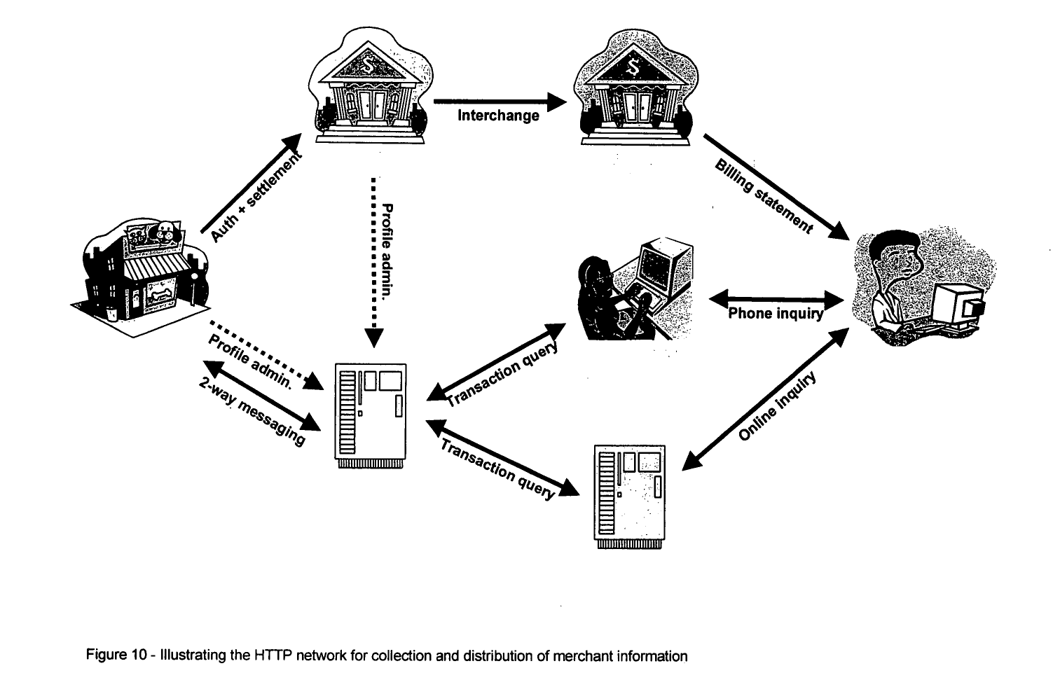

FIG. 10 illustrates a network, in accordance with one embodiment of the present invention, for the purposes of allowing establishment, maintenance, and access of merchant entity and contact profile information within the Merchant Profile Database. For the purposes of the present invention a network is defined as a set of interested parties, utilizing common internetworking communications facilities, protocols, and applications to establish, maintain, and access information in the MPD from diverse geographical locations.

In accordance with a preferred embodiment of the present invention, the following is a list of participants in the network and their roles in accessing the MPD:

1. Cardholders

Cardholders utilize the telecommunications facilities of their Internet Service Provider (ISP), the Internet, the HTTP(S) protocol, and a web browser or other third-party software application to access merchant profile information from within the electronic/online billing environment of their card-issuing bank. Merchant profile information is typically accessed by the billing system in realtime when the cardholder indicates a question about a billed transaction by clicking on the transaction description or another link, and then formatted by the billing system into an information page to be displayed within the cardholder's web browser or personal financial management application.

2. Card-Issuing Bank

Employees of the card-issuing bank utilize the telecommunications facilities of their ISP, the Internet, the HTTP(S) protocol, and either a web browser or other proprietary or third-party software application to access merchant profile information for customer service or other business purposes. Merchant profile information will typically be accessed by a customer service representative working with the card-issuing bank's call center environment, when a cardholder uses the telephone to call in and inquire as to the validity or fulfillment of a billed transaction.

3. Merchant-Acquiring Bank

Employees of the merchant-acquiring bank utilize the telecommunications facilities of their ISP, the Internet, the HTTP(S) protocol, the FTP protocol, and either a web browser or proprietary or third-party software application to establish, maintain, and access merchant profile information in the MPD for merchants with whom the bank has a business relationship under which the bank acquires credit and debit card transactions from the merchant. Establishment and maintenance of profile information is performed using either by-record or batch upload interfaces or other appropriate means. Access is preferably performed using a by-record interface.

4. Merchant

Employees of the merchant utilize the telecommunications facilities of their ISP, the Internet, the HTTP(S) protocol, the FTP protocol, and either a web browser or other proprietary or third-party software application to establish, maintain, and access merchant profile information in the MPD for points of sale owned and operated by the merchant.

5. Service Provider

The service provider maintains the MIPD and all associated applications for use by the other parties to the network, according to accepted industry standards of performance, reliability, availability, integrity, and security.

The network thus established allows for relevant merchant contact information to be collected from merchants and merchant-acquiring banks, and distributed in realtime on-demand to card-issuing banks and cardholders. In this embodiment, the service provider. is responsible for providing secure access to relevant interfaces for all parties to the network.

Another embodiment of the present invention allows credit and debit card issuers to subscribe to the content of the MPD in order to establish an instance of the MPD within their own data processing environments, such that the information contained in the MPD can be accessed by the issuer for various purposes as described above. In this embodiment the merchant and acquirer side of the network as illustrated in FIG. 9 operates as previously described to allow collection and maintenance of the merchant contact profile information, but the issuer side of the network is replaced with a system that delivers updated copies of the MPD data files to the subscribing issuer on a regular basis.

It is to be understood that the embodiments and variations shown and described herein are merely illustrative of the principles of this invention and that various modifications may be implemented by those skilled in the art without departing from the scope and spirit of the invention.

What is claimed is:

1. A system for resolving a transaction inquiry comprising:
a database, the database containing information relating to a merchant, including merchant contact information; and
a processor, the processor coupled to the database, whereby the processor associates information relating to a transaction involving the merchant, including transaction date, value and location with the merchant information.

2. The system according to claim 1, wherein the merchant contact information includes merchant name, merchant address, merchant city, merchant state, merchant zip code, and merchant telephone number.

3. The system according to claim 2, wherein the merchant contact information further includes merchant e-mail.

4. The system according to claim 2, wherein the merchant contact information further includes merchant logo.

5. The system according to claim 1, further comprising a second database, whereby the second database contains the information relating to a transaction.

6. A system for creating a functionally unique merchant index key comprising:
a database containing information relating to a transaction, including a transaction description, transaction location, including city and state, and merchant category code; and
a processor, the processor coupled to the database, whereby the processor accesses the information relating to a transaction and generates the functionally unique merchant index key.

7. The system according to claim 6, further comprising a network, wherein the processor is coupled to the network and the information relating to a transaction is transmitted to the database via the network.

8. The system according to claim 6, wherein the functionally unique merchant index key is utilized to identify a merchant and obtain merchant information relating to a particular transaction.

9. A system for processing data and accessing merchant information comprising:
a database, the database containing information relating to a merchant, including merchant contact information; and
a processor, the processor locating the information relating to a merchant using a unique merchant identifier generated from information relating to a transaction involving the merchant, including a transaction description, transaction location, including city and state, and merchant category code.

10. A system for storing and accessing merchant information comprising:
a database, the database containing information relating to a merchant, including a plurality of sets of merchant contact information for the merchant, each of which corresponds to one of a plurality of unique transaction identifiers; and
a processor, the processor controlling the storing of a first set of merchant contact information corresponding to a first unique transaction identifier in the database and a second set of merchant contact information corresponding to a second unique transaction identifier in the database.

11. The system according to claim 10, wherein the first set of merchant contact information is provided based on the first unique transaction identifier.

12. The system according to claim 10, wherein the second set of merchant contact information is provided based on the second unique transaction identifier.

13. A method for resolving a transaction inquiry comprising:
storing in a database information relating to a merchant, including merchant contact information;
associating the merchant contact information with information relating to a transaction involving the merchant, including transaction date and location; and
resolving a transaction inquiry by providing merchant contact information based on the transaction involving the merchant.

14. The method according to claim 13, wherein the merchant contact information includes merchant name, merchant address, merchant city, merchant state, merchant zip code, and merchant telephone number.

15. The method according to claim 14, wherein the merchant contact information further includes merchant e-mail.

16. The method according to claim 14, wherein the merchant contact information further includes merchant logo.

17. The method according to claim 13, wherein the information relating to a transaction involving the merchant, including transaction date and location is located in a second database.

18. A method for creating a functionally unique merchant index key comprising:
storing in a database information relating to a transaction, including a transaction description, transaction location, including city and state, and merchant category code in a database;
accessing the information relating to a transaction; and
generating the functionally unique merchant index key based on the information relating to a transaction.

19. The method according to claim 18, further comprising transmitting the information relating to a transaction the database via a network.

20. The system according to claim 18, further comprising identifying a merchant and obtaining merchant information relating to a particular transaction using the functionally unique merchant index key.

21. A method for processing data and accessing merchant information comprising:
storing in a database information relating to a merchant, including merchant contact information; and
locating the information relating to the merchant using a unique merchant identifier generated from information relating to a transaction involving the merchant, including a transaction description, transaction location, including city and state, and merchant category code.

22. A method for storing and accessing merchant information comprising:
storing the merchant information in a database, including a first set of merchant contact information corresponding to a first unique transaction identifier and a second set of merchant contact information corresponding to a second unique transaction identifier; and
accessing the merchant information, including a plurality of sets of merchant contact information for the merchant, using a corresponding one of a plurality of unique transaction identifiers.

23. The method according to claim 22, further comprising resolving a transaction inquiry utilizing the first set of merchant contact information.

24. The method according to claim 22, wherein the first set of merchant contact information is accessed based on the first unique transaction identifier.

25. The method according to claim 22, wherein the second set of merchant contact information is accessed based on the second unique transaction identifier.

26. A computer readable file containing a program that provides for the resolving of transaction inquiries comprising:
storing in a database information relating to a merchant, including merchant contact information, and information relating to a transaction involving the merchant, including transaction date and location;
associating the merchant contact information with the transaction involving the merchant; and
resolving transaction inquiries by providing merchant contact information based on the transaction involving the merchant.

27. A computer readable file containing a program that provides for the processing of data and accessing merchant information comprising:
storing in a database information relating to a merchant, including merchant contact information; and
locating the information relating to the merchant using a unique merchant identifier generated from information relating to a transaction involving the merchant, including a transaction description, transaction location, including city and state, and merchant category code.
